(19) United States
(12) Patent Application Publication
(10) Pub. No.: US 2026/0143480 A1
(43) Pub. Date: May 21, 2026

(54) REFERENCE SIGNAL BASED BEAM REFINEMENT

(71) Applicant: Lenovo (United States) Inc., Morrisville, NC (US)

(72) Inventors: Sher Ali Cheema, Ilmenau (DE); Ahmed Hindy, Aurora, IL (US)

(21) Appl. No.: 18/949,914

(22) Filed: Nov. 15, 2024

(51) Int. Cl. H04W 72/044; H04W 72/54

(52) U.S. Cl. CPC H04W 72/046; H04W 72/54

(57) ABSTRACT

Various aspects of the present disclosure relate to receiving information that indicates a first set of beams mapping to a second set of beams comprising at least one group of beams, where each beam in the first set of beams is mapped to the at least one group of beams of the second set of beams. Aspects of the present disclosure may relate to selecting a beam of the first set of beams and performing a set of one or more measurements on at least one beam of the at least one group of beams of the second set of beams, wherein the at least one beam corresponds to the selected beam of the first set of beams. Aspects of the present disclosure may relate to performing wireless communication based at least in part on the performed set of one or more measurements.

### TECHNICAL FIELD

The present disclosure relates to wireless communications, and more specifically to techniques for beam management for wireless communication.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE for wireless communication is described. The UE may be configured to, capable of, or operable to receive information that indicates a first set of beams mapping to a second set of beams including at least one group of beams, where each beam in the first set of beams is mapped to the at least one group of beams of the second set of beams; select a beam of the first set of beams and performing a set of one or more measurements on at least one beam of the at least one group of beams of the second set of beams, where the at least one beam corresponds to the selected beam of the first set of beams; and perform wireless communication based at least in part on the performed set of one or more measurements.

A processor for wireless communication is described. The processor may be configured to, capable of, or operable to receive information that indicates a first set of beams mapping to a second set of beams including at least one group of beams, where each beam in the first set of beams is mapped to the at least one group of beams of the second set of beams; select a beam of the first set of beams and performing a set of one or more measurements on at least one beam of the at least one group of beams of the second set of beams, where the at least one beam corresponds to the selected beam of the first set of beams; and perform wireless communication based at least in part on the performed set of one or more measurements.

A method performed or performable by a UE for wireless communication is described. The method may include receiving information that indicates a first set of beams mapping to a second set of beams including at least one group of beams, where each beam in the first set of beams is mapped to the at least one group of beams of the second set of beams; selecting a beam of the first set of beams and performing a set of one or more measurements on at least one beam of the at least one group of beams of the second set of beams, where the at least one beam corresponds to the selected beam of the first set of beams; and performing wireless communication based at least in part on the performed set of one or more measurements.

A base station for wireless communication is described. The base station may be configured to, capable of, or operable to transmit information that indicates a first set of beams mapping to a second set of beams comprising at least one group of beams, where each beam in the first set of beams is mapped to the at least one group of beams of the second set of beams; and perform wireless communication based at least in part on the transmitted information.

A processor for wireless communication is described. The processor may be configured to, capable of, or operable to transmit information that indicates a first set of beams mapping to a second set of beams comprising at least one group of beams, where each beam in the first set of beams is mapped to the at least one group of beams of the second set of beams; and perform wireless communication based at least in part on the transmitted information.

A method performed or performable by a base station for wireless communication is described. The method may include transmitting information that indicates a first set of beams mapping to a second set of beams comprising at least one group of beams, where each beam in the first set of beams is mapped to the at least one group of beams of the second set of beams; and performing wireless communication based at least in part on the transmitted information.

### BRIEF DESCRIPTION OF THE DRAWINGS

FIG. 1 illustrates an example of a wireless communication system in accordance with aspects of the present disclosure.

FIG. 2 illustrates an example of a protocol stack, in accordance with aspects of the present disclosure.

FIGS. 3A and 3B illustrate examples of satellite-beam-to-cell mapping, in accordance with aspects of the present disclosure.

FIGS. 4A and 4B illustrate examples of frequency reuse for a group of cells, in accordance with aspects of the present disclosure.

FIGS. 5 and 6 illustrate examples of beam mapping, in accordance with aspects of the present disclosure.

FIG. 7 illustrates an example of a procedure that supports beam management, in accordance with aspects of the present disclosure.

FIG. 8 illustrates an example of a UE, in accordance with aspects of the present disclosure.

FIG. 9 illustrates an example of a processor, in accordance with aspects of the present disclosure.

FIG. 10 illustrates an example of a NE, in accordance with aspects of the present disclosure.

FIG. 11 illustrates a flowchart of a method performed by a UE, in accordance with aspects of the present disclosure.

FIG. 12 illustrates a flowchart of a method performed by a NE, in accordance with aspects of the present disclosure.

### DETAILED DESCRIPTION

Some wireless communication systems may support beam refinement for beam-based communication. Beam-based communication uses beamforming to direct radio frequency (RF) signals in targeted, directional beams. Using beamforming, a transmitter of a NE and/or a UE may shape and/or steer directional beams to a specific location. Additionally, a receiver of a NE and/or a UE may use beamforming to improve reception in a direction corresponding to the directional beams. As used herein, the directed RF signal output (e.g., transmitted) by the transmitter is referred to as a “transmit beam.” Similarly, the term “receive beam” refers to the directionally focused reception (i.e., receiver beamforming) of an RF signal.

The beam refinement process includes using a broader beam (i.e., having a wider coverage area or beam footprint) to establish an initial connection and switching to a narrower beam (i.e., within the coverage of the broader beam) for improved data throughput, minimized interference, and/or extended range. For example, a UE may scan and measure a plurality of narrower beams within the coverage of the broader beam, select a particular one of the narrower beams (e.g., based on reference signal received power (RSRP), reference signal received quality (RSRQ), or signal-to-noise ratio (SNR), or similar metrics), and indicate the selected beam to the a NE (e.g., base station). Thereafter, the NE may transmit on the selected beam, improving communication efficiency.

Beam management (e.g., beamforming, beam alignment, beam refinement) improves signal directivity to enhance coverage and capacity. In non-terrestrial network (NTN) deployments, where satellites are located several hundred to several thousand kilometers away from ground UEs, the importance of beam management becomes significantly greater to achieve sufficient coverage and capacity. For example, a number of beams required to span a geographic coverage area in NTN deployments may be substantially larger than in terrestrial network (TN) deployments. As such, the power consumed by beam management and the time required for beam acquisition are significantly higher. The problem becomes more critical in the case of low-cost non-geostationary orbit (NGSO) satellites, which are more power limited compared to TN-based stations. Thus, distributing the limited on-board power of a satellite across a large number of beams significantly reduces a link budget. Additionally, in NGSO systems, the beam dwelling time (i.e., the duration over which the strongest beam for a UE is expected to change, is relatively short), leads to the need for frequent beam update procedures to maintain connectivity with the UE.

One approach to addressing this problem is beam hopping, where multiple beams covering a geographic coverage area are activated for a period of time and then deactivated for a period of time, for example, in time division multiplexing (TDM) manner. However, to mitigate gaps in the geographic coverage area, the network may also employ (e.g., use) wider beams for common channels, such as common channel signaling (CCS) while reserving narrow beams for dedicated channels. This approach may require frequent switching between beams (i.e., between wider to narrow beams).

Some beam management procedures, including legacy beam refinement procedures, may supporting switching between beams (e.g., from wider to narrow beams). However, these legacy procedures may result in significant delays, as such procedures require frequent measurements of RSs. This problem is particularly evident during initial access, in which a UE performs a random access channel (RACH) transmission (e.g., a Msg1 transmission) using a spatial filter associated with a wider synchronization signal block (SSB) beam received at the UE. Additionally, the network (e.g., a base setation) also responds using a wider spatial filter for a RACH transmission (e.g., a Msg2 transmission), as the network lacks information about the specific spatial filter to be used for downlink (DL) until the beam refinement procedure is completed.

Various aspects of the present disclosure support an enhanced beam management and refinement framework that enables switching from a first beam (e.g., a wide beam) to a second beam (e.g., a narrow beam) in one step based at least in part on assistance of RSs within a beam footprint of the first beam (e.g., a wider beam footprint), particularly during the initial access. This framework enhances DL coverage in initial access where a UE may transmit a first uplink (UL) message (e.g., a random access message, such as Msg1) using narrow beam spatial filter, thus assisting a NE to transmit a second message (e.g., random access message, such as Msg2) via the second beam (e.g., the narrow beam).

While the framework is described in the context of NTN deployments, the beam refinement aspects described herein are also applicable to beam-based communication in TN deployments. Additionally, while presented as distinct solutions, one or more of the solutions described herein may be implemented in combination with each other. Aspects of the present disclosure are described in the context of a wireless communications system.

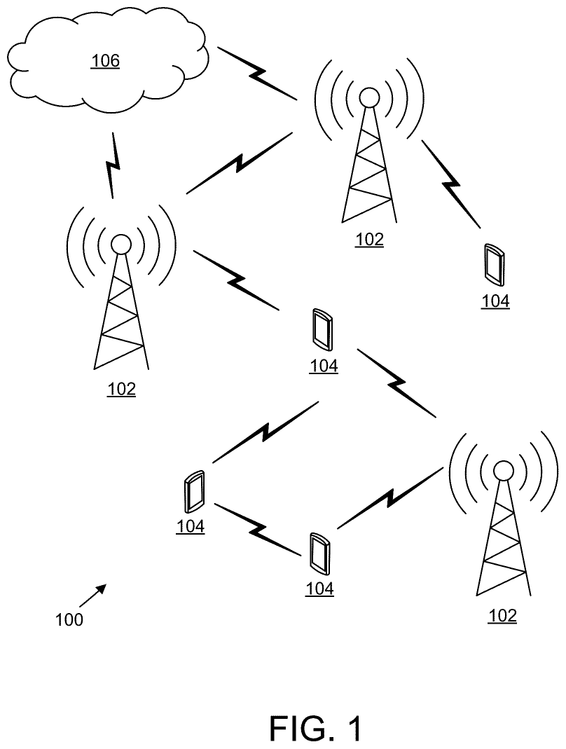

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1,μ=2, μ=3,μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1(FR1 ) (e.g., 410 MHz-7.125 GHz), frequency range #2 (FR2) (e.g., 24.25 GHz-52.6 GHz), frequency range #3(FR3 ) (e.g., 7.125 GHz-24.25 GHz), frequency range #4(FR4 ) (e.g., 52.6 GHz-114.25 GHz), frequency range #4a (FR4a) or frequency range #4-1 (FR4-1) (e.g., 52.6 GHz-71 GHz), and frequency range #5(FR5 ) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the example of FIG. 1, an NE 102 may group a set of beams into a plurality of beam groups according to at least one of an activation behavior and deactivation behavior of a beam. Additional UL and DL signaling enable refining a beam in the set of beams to a narrower beam for DL dedicated signaling to improve performance. For example, a first set of beams of a first type (e.g., a set of wide beams) for transmission of SSB may be associated with (i.e., mapped to) groups of beams of a second type (e.g., groups of narrow beams) for transmission of RS, such as transmission of channel state information (CSI) reference signal (CSI-RS). The NE 102 may indicate (e.g., signal), to a UE 104, the association (i.e., mapping) of the set of wide beams to groups of narrow beams, where each wide beam is mapped to a group of narrow beams.

In some implementations, the NE 102 and the UE 104 may support a one-step beam refinement procedure for employing narrow beams from received wide beams, where the procedure is based on an association of a set of RS (e.g., CSI-RS) with a wide beams (e.g., carrying one or more SSBs). Here, the UE 104 may receive a mapping of the set of RS to the wide beams, perform measurements on the RSs associated with the detected wide beams (e.g., SSB), and determine a spatial filter to use for transmission of UL communications and reception of DL communications. The UE 104 may indicate, to the NE 102, the determined spatial filter as described in further detail herein.

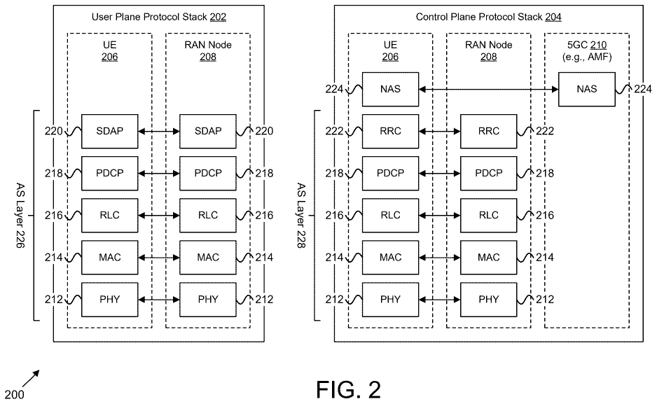

FIG. 2 illustrates an example of a protocol stack 200, in accordance with aspects of the present disclosure. While FIG. 2 shows a UE 206, a RAN node 208, and a 5GC 210 (e.g., comprising at least an AMF), these are representative of a set of UEs 104 interacting with an NE 102 (e.g., base station) and a CN 106. As depicted, the protocol stack 200 comprises a User Plane protocol stack 202 and a Control Plane protocol stack 204. The User Plane protocol stack 202 includes a physical (PHY) layer 212, a MAC sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least the RRC sublayer 222, the PDCP sublayer 218, the RLC sublayer 216, the MAC sublayer 214, and the PHY layer 212. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In some implementations, the PHY layer 212 may send an indication of beam failure to a MAC entity at the MAC sublayer 214. The MAC sublayer 214 offers logical channels (LCHs) to the RLC sublayer 216. The RLC sublayer 216 offers RLC channels to the PDCP sublayer 218.

The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of carrier aggregation (CA) and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through LCHs. The MAC sublayer 214 therefore performs multiplexing and demultiplexing between LCHs and transport channels: the MAC sublayer 214 in the transmitting side constructs MAC PDUs (also known as Transport Blocks (TBs)) from MAC Service Data Units (SDUs) received through LCHs, and the MAC sublayer 214 in the receiving side recovers MAC SDUs from MAC PDUs received through transport channels.

The MAC sublayer 214 provides a data transfer service for the RLC sublayer 216 through LCHs, which are either control LCHs which carry control data (e.g., RRC signaling) or traffic LCHs which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3rd Generation Partnership Project (3GPP) system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some implementations, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

It should be noted that throughout the disclosure, the terms “symbol” and “slot” are terms used to refer to a time unit with a particular duration. For example, symbol could be a fraction/percentage of an OFDM symbol length associated with a particular subcarrier spacing (SCS). As another example, a slot may refer to a predetermined set of symbols and can be a fraction/portion of a radio frame. In the following, an UL transmission can be comprised of multiple transmissions and may contain a physical uplink shared channel (PUSCH) transmission, a physical uplink control channel (PUCCH) transmission, physical random access channel (PRACH) transmission, a scheduling request (SR), and/or an UL reference signal (RS) such as sounding reference signal (SRS).

In NR TN, beam switching and BWP switching are independent with no direct association with each other. However, in NTN, for a frequency reuse factor of greater than one, there may be a one-to-one (1:1) or one-to-multiple (1:M) mapping between BWPs and beams (and vice versa). Moreover, the beam-level mobility in the case of low-earth orbit (LEO) satellites can result in frequent beam and BWP switching.

At least two different cell mapping scenarios are supported in NTN, wherein one or more satellite beams are mapped to a cell. Note that a satellite beam may consist of one or more SSB beams.

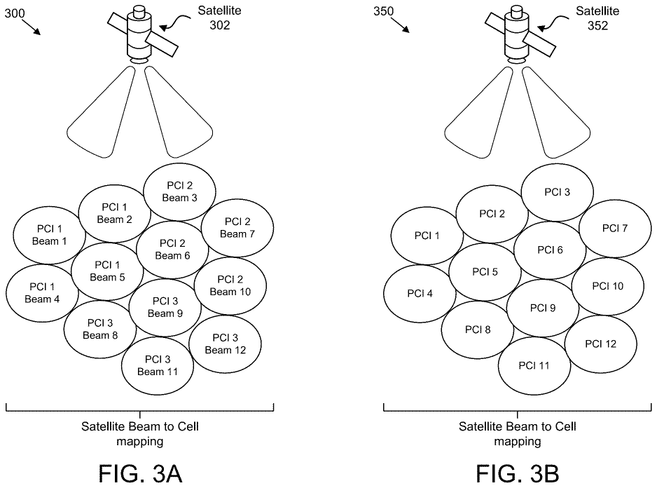

FIG. 3A illustrates a satellite-beam-to-cell mapping 300, in accordance with aspects of the present disclosure. The satellite-beam-to-cell mapping 300 may implement or be implemented by aspects of the wireless communication system 100, or may implement or be implemented by aspects of the protocol stack 200. For example, the satellite-beam-to-cell mapping 300 may include a satellite 302, which may be examples of a NE as described herein. The satellite 302 may be associated with one or more cells (also referred to as geographic coverage areas) of an NTN. The one or more cells may be associated with an identifier, such a physical cell identifier (PCI) and each beam of a set of beams of the satellite 302 may be mapped to the PCI.

By way of example, a first beam (Beam 1) may be mapped to a first PCI (PCI 1), a second beam (Beam 2) may be mapped to the first PCI (PCI 1), a fourth beam (Beam 4) may be mapped to the first PCI (PCI 1), and a fifth beam (Beam 5) may be mapped to the first PCI (PCI 1). Additionally, or alternatively, a third beam (Beam 3) may be mapped to a second PCI (PCI 2), sixth beam (Beam 6) may be mapped to the second PCI (PCI 2), a seventh beam (Beam 7) may be mapped to the second PCI (PCI 2), and a tenth beam (Beam 10) may be mapped to the second PCI (PCI 2). Additionally, or alternatively, an eighth beam (Beam 8) may be mapped to a third PCI (PCI 3), a nineth beam (Beam 9) may be mapped to the third PCI (PCI 3), an eleventh beam (Beam 11) may be mapped to the third PCI (PCI 3), and a twelfth beam (Beam 12) may be mapped to the third PCI (PCI 3).

In the example of FIG. 3A, each beam of a cell is associated with the same PCI. Additionally, each beam of the set of beams of the satellite 302 may be associated with a separate beam identifier. While in the depicted embodiment the beam identifier (i.e., ‘Beam N’) is globally unique (e.g., among all beam supported by the satellite 302), in other implementations, the beam identifier may be only unique on the cell-level, but the combination of PCI (i.e., ‘PCI M’) and beam identifier (i.e., ‘Beam N’)may be globally unique (e.g., among all beam supported by the satellite 302).

FIG. 3B illustrates a satellite-beam-to-cell mapping 350, in accordance with aspects of the present disclosure. The satellite-beam-to-cell mapping 350 may implement or be implemented by aspects of the wireless communication system 100, or may implement or be implemented by aspects of the protocol stack 200. For example, the satellite-beam-to-cell mapping 350 may include a satellite 352, which may be examples of a NE as described herein. The satellite 352 may be associated with one or more cells (also referred to as geographic coverage areas) of an NTN. The one or more cells may be associated with an identifier, such a PCI and each cell of the satellite 352, including each beam of the satellite 352 may be mapped to a corresponding PCI. In other words, each beam of the satellite 352 may be considered as a separate cell. As such, the corresponding PCI associated with each beam is unique to each beam in the NTN, and thus no separate beam identifier is needed.

By way of example, a first beam (and cell) of the satellite 352 may be associated with a first PCI (PCI 1), a second beam (and cell) of the satellite 352 may be associated with a second PCI (PCI 2), a third beam (and cell) of the satellite 352 may be associated with a third PCI (PCI 3), a fourth beam (and cell) of the satellite 352 may be associated with a fourth PCI (PCI 4), a fifth beam (and cell) of the satellite 352 may be associated with a fifth PCI (PCI 5), a sixth beam (and cell) of the satellite 352 may be associated with a sixth PCI (PCI 6), a seventh beam (and cell) of the satellite 352 may be associated with a seventh PCI (PCI 7), an eighth beam (and cell) of the satellite 352 may be associated with an eighth PCI (PCI 8), a nineth beam (and cell) of the satellite 352 may be associated with a nineth PCI (PCI 9), a tenth beam (and cell) of the satellite 352 may be associated with a tenth PCI (PCI 10), an eleventh beam (and cell) of the satellite 352 may be associated with an eleventh PCI (PCI 11), and a twelfth beam (and cell) of the satellite 352 may be associated with a twelfth PCI (PCI 12).

In case of one beam per cell deployment, a PHY layer (i.e., L1) behavior for NTN might be similar to a PHY layer (i.e., L1) behavior for TN, although more higher layer procedures may be required due to frequent cell/beam handover, especially for satellite access provided by LEO satellites. In case of operation with multiple beams per cell, the PHY layer (i.e., L1) behavior for NTN may reuse one or more L1 beam management techniques defined for TNs.

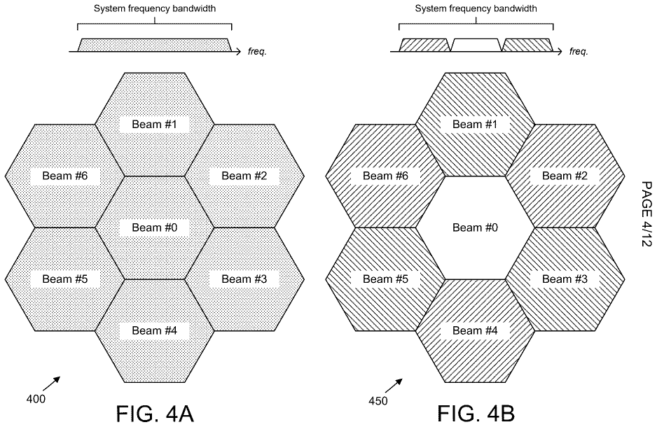

FIG. 4A illustrates an example of frequency reuse 400 for a group of cells, in accordance with aspects of the present disclosure. The frequency reuse 400 for a group of cells may implement or be implemented by aspects of the wireless communication system 100, or may implement or be implemented by aspects of the protocol stack 200. For example, the frequency reuse 400 for a group of cells may include one or more operations and/or signaling performed by a NE (e.g., a satellite) and/or a UE. In the example of FIG. 4A, a frequency reuse factor (FRF) is equal to one (FRF-1).

In accordance with FRF-1, all beams (and cells) are associated with (e.g., use) the same frequencies, thereby yielding inter-cell/inter-beam interference. However, according to an FRF-1 scheme, a per-beam bandwidth can occupy an entire wideband carrier. For example, a system bandwidth, including frequencies of the system bandwidth, may be applicable for each of one or more of a null beam (Beam #0), a first beam (Beam #1), a second beam (Beam #2), a third beam (Beam #3), a fourth beam (Beam #4), a fifth beam (Beam #5), and a sixth beam (Beam #6).

FIG. 4B illustrates an example of frequency reuse 450 for a group of cells, in accordance with aspects of the present disclosure. The frequency reuse 450 for a group of cells may implement or be implemented by aspects of the wireless communication system 100, or may implement or be implemented by aspects of the protocol stack 200. For example, the frequency reuse 450 for a group of cells may include one or more operations and/or signaling performed by a NE (e.g., a satellite) and/or a UE. In the example of FIG. 4B, an FRF of 3 (FRF-3) may be implemented to reduce or mitigate the inter-cell/inter-beam interference.

In some examples of NR NTN, frequency reuse schemes (e.g., where an FRF is greater than one) may be implemented to reduce or mitigate inter-cell/inter-beam interference. In some other examples, spatial frequency reuse techniques may be used to improve a signal-to-interference-plus-noise ratio (SINR); however, spatial frequency reuse inherently limits the per-beam bandwidth and the system capacity. Although legacy FRF-3 schemes offer protection against inter-cell interference, only a third of spectral resources are used within each cell.

In case of frequency reuse larger than one, using BWPs to enable a frequency reuse may be implemented (e.g., mapping different BWPs to different parts of the system bandwidth and different beams may enable L1-based mobility within a large cell). Particularly, for a flexible frequency reuse, a UE may be configured with beam-specific BWP to replace the traditional role of the component carrier, which is not as flexible as a BWP. Thus, for NTN the same component carrier may be used on all cells (e.g., frequency reuse of 1), but each beam is assigned a beam-specific BWP.

For example, a system bandwidth may be configured (e.g., segmented, split, divided) including frequencies of the system bandwidth into one or more BWPs, where a first set of one or more BWPs may be associated with a first set of one or more beams and a second set of one or more BWPs may be associated with a second set of one or more beams. For example, one or more of a null beam (Beam #0) may be associated with a first set of one or more BWPs, while a second set of one or more beams, including a first beam (Beam #1), a second beam (Beam #2), a third beam (Beam #3), a fourth beam (Beam #4), a fifth beam (Beam #5), and/or a sixth beam (Beam #6) may be associated with a second set of one or more BWPs.

Additionally, for a configuration of beam specific BWPs in NTN, one or more configuration parameters may include a starting frequency, a BWP size (i.e., a number of subcarriers comprising the BWP), and a subcarrier spacing as defined for TNs. In addition, for NTN an indication of the associated beam needs to be added (e.g., a beam-index, such as CSI-RS associated with a beam).

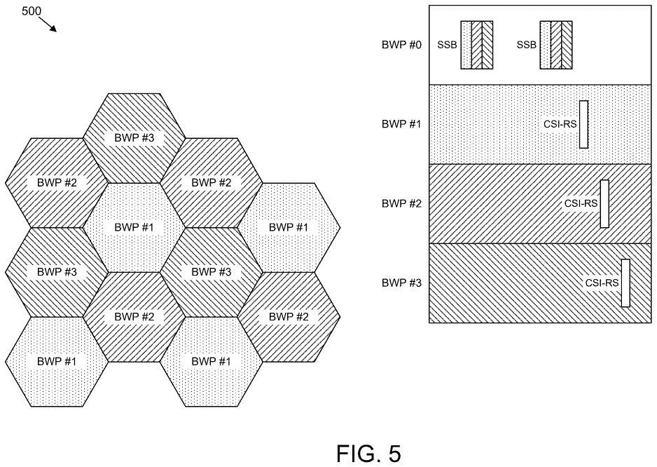

FIG. 5 illustrates an example of a mapping scenario 500 where multiple beams are in a cell and where each beam is mapped to a BWP, in accordance with aspects of the present disclosure. The mapping scenario 500 may implement or be implemented by aspects of the wireless communication system 100, or may implement or be implemented by aspects of the protocol stack 200, or may implement or be implemented by aspects of the satellite-beam-to-cell mapping 300 or the satellite-beam-to-cell mapping 350.

By way of example, the initial BWP#0 may be used throughout the cell and may correspond to a wider beam used to communicate on common channels within the cell, including SSB transmissions. Additionally, each beam may be associated with a serving BWP, e.g., for communicating using dedicated channels. Here, the serving BWPs include the BWP #1, the BWP #2, and the BWP #3. As indicated in FIG. 5, the BWP #0 may correspond to a first frequency band, the BWP #1 may correspond to a second frequency band, the BWP #2 may correspond to a third frequency band, and the BWP #3 may correspond to a fourth frequency band. Further, the NE may transmit CSI-RS for beam management on each serving BWP.

In the example of FIG. 5, a UE may first use the initial BWP #0, but then switches from the initial BWP #0 to the serving BWP #x (e.g., one of the BWP #1, the BWP #2, or the BWP #3). Similarly in this case, SSBs via all beams within the cell may be transmitted on BWP #0. In one embodiment, the UE performs DL synchronization and RACH procedure on BWP #0. After entering the RRC connected state, the BWP corresponding to the detected SSB (i.e., satellite beam) may be configured to the UE as an active BWP (e.g., RRC-configured BWP). This requires that the satellite beam carries the SSB on BWP #0 in addition to a physical downlink control channel (PDCCH) and/or physical downlink shared channel (PDSCH) transmission on the associated BWP.

In other words, the BWP #0 can be used for initial cell access with all beams and corresponding SSBs. For a connected UE, an active BWP #1, #2, or #3 can be used with several satellite beams. Whenever the UE makes measurements on a BWP that is different from the BWP of the current serving satellite beam, the UE will need to retune its carrier frequency for measurements on the non-active BWP and perform frequency compensation to report measurements frequently—i.e., every 10 seconds typically in LEO scenario with earth-moving beams.

Regarding BWPs, a UE may be configured with up to four BWPs in the DL. In one embodiment, only a single DL BWP may be active at a given time. In another embodiment, the UE may support multiple DL BWPs being simultaneously active concurrently (i.e., where DL signaling is received simultaneously on multiple DL BWPs). The UE is not expected to receive PDSCH, PDCCH, or CSI-RS (except for radio resource management (RRM)) outside an active BWP.

A UE can be configured with up to four BWPs in the UL. In one embodiment, only a single UL BWP may be active at a given time. In another embodiment, the UE may support multiple DL BWPs being simultaneously active concurrently (i.e., where DL signaling is received simultaneously on multiple DL BWPs). If a UE is configured with a supplementary uplink (SUL), the UE may be additionally configured with up to four BWPs in the SUL, with a single SUL BWP being active at a given time. In certain implementations, the UE may not transmit PUSCH or PUCCH outside an active BWP. In certain implementations, for an active cell, the UE may not transmit SRS outside the active BWP(s).

Accordingly, a UE may receive PDCCH and PDSCH transmissions in a DL BWP according to a configured SCS and cyclic prefix (CP) length for the DL BWP. A UE transmits PUCCH and PUSCH in an UL BWP according to a configured SCS and CP length for the UL BWP.

In the following descriptions, the terms antenna, panel, antenna panel, device panel and UE panel are used interchangeably. An antenna panel may be a hardware that is used for transmitting and/or receiving radio signals at frequencies lower than 6 GHz (e.g., FR1), or higher than 6 GHz (e.g., FR2) or millimeter wave (i.e., “mmWave”). In some implementations, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. The capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device antenna panel (e.g., of a UE or RAN node) may be a physical or logical antenna array comprising a set of antenna elements or antenna ports that share a common or a significant portion of an RF chain (e.g., in-phase/quadrature (I/Q) modulator, analog-to-digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of: Unit of antenna group to control its transmit (Tx) beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping.

A device may report its capability with respect to the “device panel” to the gNB or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed. Two antenna ports are said to be quasi-co-located (QCL'ed) if the large-scale properties of the channel over which a symbol on one antenna port is conveyed can be inferred from the channel over which a symbol on the other antenna port is conveyed. The large-scale properties include one or more of: a delay spread, a Doppler spread, a Doppler shift, an average gain, an average delay, or spatial receive (Rx) parameters. Two antenna ports may be QCL'ed with respect to a subset of the large-scale properties and different subset of large-scale properties may be indicated by a quasi-co-location (QCL) Type. For example, the parameter qcl-Type may take one of the following values: QCL-TypeA (also referred to as ‘typeA’), QCL-TypeB (also referred to as ‘typeB’), QCL-TypeC (also referred to as ‘typeC’), or QCL-TypeD (also referred to as ‘typeD’).

For QCL-TypeA, two antenna ports (or beams) are QCL'ed with respect to Doppler shift, Doppler spread, average delay, and delay spread. For QCL-TypeB, two antenna ports (or beams) are QCL'ed with respect to Doppler shift and the Doppler spread. For QCL-TypeC, two antenna ports (or beams) are QCL'ed with respect to Doppler shift and the average delay. For QCL-TypeD, two antenna ports (or beams) are QCL'ed with respect to the spatial Rx parameter(s).

The spatial Rx parameters may include one or more of: angle of arrival (AoA), dominant AoA, average AoA, angular spread, power angular spectrum (PAS) of AoA, average angle of departure (AoD), PAS of AoD, transmit/receive channel correlation, transmit/receive beamforming, spatial channel correlation, etc.

An “antenna port” according to an embodiment may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a transmission configuration indication (TCI) state associated with a target transmission can indicate parameters for configuring a QCL relationship between the target transmission (e.g., target reference signal (RS) of demodulation RS (DM-RS) ports of the target transmission during a transmission occasion) and a source RS(s) (e.g., SSB, CSI-RS, and/or SRS) with respect to QCL type parameter(s) indicated in the corresponding TCI state. A device can receive a configuration of a plurality of transmission configuration indicator states for a serving cell for transmissions on the serving cell.

In some of the implementations described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the RS (e.g., DL RS such as SSB/CSI-RS). In another example, the device may transmit the target transmission with the same spatial domain transmission filter used for the transmission of the RS (e.g., UL RS such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may comprise a source RS which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides a QCL-TypeD indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL-TypeD properties in the joint TCI state. The spatial setting of the UL transmission may be according to the spatial relation with a reference to the source RS configured with qcl-Type set to ‘typeD’in the joint TCI state.

The present disclosure uses the following notions interchangeably: network nodes, transmit-receive point (TRP), panel, set of antennas, set of antenna ports, uniform linear array, cell, node, radio head, communication (e.g., signals/channels) associated with a control resource set (CORESET) pool, communication associated with a TCI state from a transmission configuration comprising at least two TCI states.

As used herein, a tracking reference signal (TRS) corresponds to a non-zero power (NZP) CSI-RS resource set with a parameter ‘trs-info’ being configured. Additionally, a CSI-RS for beam management may correspond to CSI-RS associated with an NZP CSI-RS resource set with a parameter ‘repetition’ being configured. In contrast, a CSI-RS for CSI corresponds to an NZP CSI-RS resource set with neither parameters ‘trs-info’ nor ‘repetition’ being configured.

Hereafter, a matrix implies a sequence of fields of an arbitrary dimension, including an array (vector) of values, a standard 2D matrix and more generally a Q-dimensional matrix (tensor) wherein Q is an integer value greater than or equal to 2.

The present disclosure uses the following notions interchangeably: CSI report setting, CSI report configuration, CSI reporting configuration interchangeably to represent the same notion. Hereafter, a CSI framework or procedure associated with up to 3GPP Rel-18 is referred to as legacy behavior. As used herein, a beam may correspond to at least one of an NZP CSI-RS transmitted over a CSI-RS resource, or an SSB signal.

Several implementations are described below. According to a possible implementation, one or more elements or features from one or more of the described implementations may be combined.

As will be understood by one of skill in the art, the following configuration and reporting aspects may be applied for either of NTN scenarios. i.e., when one beam corresponds to one cell or when multiple beams are configured within a cell. Note that the following configuration and reporting aspects may be applied to either of cell NTN cell layout configurations. i.e., earth-fixed cells, quasi earth-fixed cells or earth moving cells.

According to aspects of a first solution, the network (e.g., a base station) configures a UE with a set of RSs (e.g., CSI-RS) corresponding to a set of narrow beams that are associated with a wider beam (or wider beam footprint) carrying common channel signal (CCS) information (e.g., SSB beams) during initial access or while in connected mode.

Upon reception of such configuration, the UE performs measurements on the set of RSs corresponding to the detected wider beam and uses the narrow spatial filter corresponding to one of the RSs within the set for UL transmission. In such implementations, the selection of the spatial filter for UL transmission is based on selection of a best precoding matrix or the best signal strength values (e.g., RSRP, RSRQ) from the measurements on the set of RSs. In one embodiment, the UE transmits an explicit indication of the selected spatial filter to the base station, i.e., in the UL transmission. In another embodiment, the UE may implicitly indicate the selected spatial filter from the set of RSs to the base station.

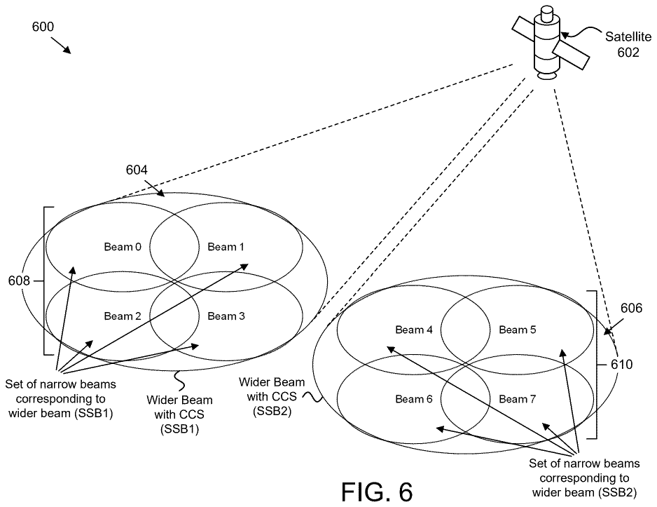

FIG. 6 illustrates a mapping 600 of broader beams to groups of narrower beams, in accordance with aspects of the present disclosure. The mapping 600 may implement or be implemented by aspects of the wireless communication system 100, or may implement or be implemented by aspects of the protocol stack 200, or may implement or be implemented by aspects of the satellite-beam-to-cell mapping 300 or the satellite-beam-to-cell mapping 350.

In the depicted example, the satellite 602 supports at least two wider beams carrying CCS, including a first broader beam 604 associated with the transmission of SSB1 (i.e., SSB with index #1), and a second broader beam 606 associated with the transmission of SSB2 (i.e., SSB with index #2). Each wider/broader beam is associated with a group of narrower beams corresponding the SSB, where the group of narrower beams is encompassed by the beam footprint of the corresponding broader/wider beam.

In the depicted example, the first group 608 of narrower beams includes the following beam indices: Beam 0, Beam 1, Beam 2, Beam 3. As depicted, each narrower beam in the first group 608 overlaps with the first broader beam 604, and the beam footprint of the first broader beam 604 encompasses the beam footprints of the first group 608 of narrower beams.

Additionally, the second group 610 of narrower beams includes the following beam indices: Beam 4, Beam 5, Beam 6, Beam 7. As depicted, each narrower beam in the second group 610 overlaps with the second broader beam 606, and the beam footprint of the second broader beam 606 encompasses the beam footprints of the second group 610 of narrower beams.

As noted above, each group of narrower beams corresponds to a set of RSs (e.g., CSI-RS), and each group of narrower beams is associated with an SSB beam (i.e., a wider/broader beam). In one example, the RSs are part of broadcast messages along with other necessary information required for initial access. In various implementations, the number of groups of narrower beams (i.e., CSI-RS beam groups) is equal to the number of SSB beams.

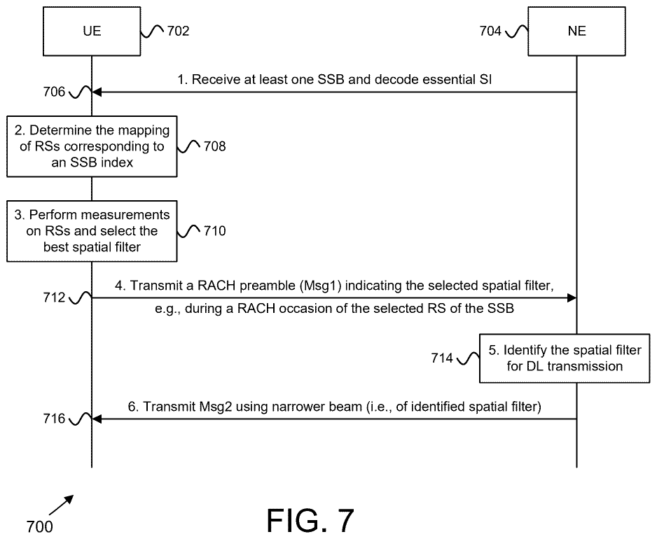

FIG. 7 illustrates an example of a procedure 700 that supports beam management, in accordance with aspects of the present disclosure. The procedure 700 may implement or be implemented by aspects of the wireless communication system 100. For example, the procedure 700 may include a UE 702 and a NE 704 (e.g., base station), which may be one or more examples of equipment described herein with reference to FIG. 1. In the following description of the procedure 700, one or more operations or signaling performed by the UE 702 or the NE 704 may performed or signaled in a different order than the example order shown, or the one or more operations or signaling performed by the UE 702 or the NE 704 may be performed or signaled at different times than the example time shown. Some operations or signaling may also be omitted, or other operations or signaling may be added. Additionally, while the UE 702 and the NE 704 are shown to perform the operations of the procedure 700, some operations of the procedure 700 may be performed by other entities that are not shown.

The procedure 700 may support selecting a beam (e.g., a narrow beam) and indicating the selected beam (e.g., the selected narrow beam) for dedicated signaling (e.g., during initial access). In some examples, the selected beam (e.g., the selected narrow beam) may be indicated in a first message (e.g., a Msg1), in response to detecting an initial access SSB beam. Each group of narrower beams corresponds to a set of CSI-RS, and each group of narrower beams is associated with an SSB beam (i.e., a wider/broader beam). In one example, the RSs are part of broadcast messages along with other necessary information required for initial access.

At step 1 (see signaling 706), the NE 704 may transmit, and the UE 702 may receive, at least one SSB, where each SSB associated with an SSB index. As used herein, an SSB index refers to an identifier that distinguishes each SSB beam. The SSB index the UE to identify and select an SSB beam with the best signal. For example, the UE 702 and the NE 704 may perform an initial access procedure, in which the UE 702 may monitor for (e.g., scan and detect) and receive the at least one SSB on an SSB beam. In some examples, the NE 704 may transmit, and the UE 702 may receive, at least one SSB on a wide beam (e.g., a wide beam footprint). Further, the NE 704 may transmit at least one CSI-RS on a group of narrower beams corresponding to the wider SSB beam, as described herein.

Additionally, the UE 702 may receive and decode essential system information (SI) based at least in part on the received at least one SSB. For example, in response to (or based at least in part on) detecting the SSB, the UE 702 may decode essential SI required for performing a RACH procedure. One or more essential SI may be transmitted by the NE 704 and received by the UE 702 in a master information block (MIB), a system information block #1 (SIB1), a system information block #2 (SIB2), and/or system information block #19 (SIB19). For example, the SI (e.g., MIB/SIB) may include a mapping of a SSB index to a NZP CSI-RS resource set comprising a plurality of NZP CSI-RS resources.

At step 2 (see block 708), the UE 702 may determine a mapping of a set of RSs (e.g., CSI-RS) for narrow beams corresponding to an SSB index. Note that the beam footprint of each SSB beams may encompass the beam footprints of the group of narrower beams associated with the SSB beam. In some implementations, the UE 702 may search essential SI for a configuration for the RSs for the narrow beams. In other implementations, the configuration may be part of a separate SI broadcast message or, alternatively, be part of one or more SIBs for RACH or NTN.

The UE 702 may be configured with at least one parameter that indicates whether or not the UE 702 has to perform one or more measurements on the RSs (e.g., CSI-RS corresponding to a group of narrower beams). Alternatively, the UE 702 may be configured to perform the one or more measurements irrespective of any indication to perform the one or more measurements. For example, UE 702 may be configured to perform the one or more measurements whenever RSs for beam management are configured.

At step 3 (see block 710), the UE 702 may perform the one or more measurements on the RSs corresponding to the received at least one SSB. In some examples, the UE 702 selects a best SSB beam and performs the one or more measurements on the set of RSs corresponding to the SSB beam (i.e., as indicated by the mapping information determined in step 2). In another example, the SI received from the NE 704 may indicate that the UE 702 perform the set of one or more measurements on at least one set of RS (i.e., on at least one group of narrower beams). Note that each of the wider SSB beams is associated with a SSB resource, and each of the narrower beams is associated with a NZP CSI-RS resource. The NZP CSI-RS resources may be QCL'ed with the SSB resource as described in further detail below.

From the one or more measurements, the UE 702 may select a best spatial filter corresponding to one of the RSs within the set of RSs (i.e., corresponding to the RS with the beast measurements). Here, the selected spatial filter is used for UL communication (e.g., preambles, payloads, or the like associated with RACH messaging). In response to (or based at least in part on) selecting the best spatial filter, the UE 702 may identify a mapping configuration that defines a relationship (i.e., mapping) for each of the RSs of an SSB index to corresponding RACH occasions. In this way, the NE 704 may be capable of identifying the spatial filter (i.e., selected by the UE 702 for UL transmission) corresponding to one of the narrow beams, the identification of the spatial filter based on whichever RACH occasion was used by the UE 702 to transmit the UL message (e.g., Msg1).

At step 4 (see signaling 712), the UE 702 transmits at least one RACH signal to indicate the selected spatial filter to the NE 704, e.g., using RACH occasion of the selected RS of the SSB. In the depicted example, the UE 702 transmits a RACH preamble (e.g., RACH Msg1) to indicate the selected spatial filter. Alternatively, or additionally, the UE 702 may transmit a CSI report during the RACH occasion associated with the selected RS (i.e., the selected narrower beam), where the CSI report comprises an indication of the spatial filter corresponding to the selected RS. In certain implementations, the UE 702 uses the selected narrow UL beam (i.e., corresponding to the selected spatial filter) to transmit the RACH preamble.

At step 5 (see block 714), upon reception of the RACH signal (e.g., RACH preamble and/or CSI report), the NE 704 identifies the spatial filter for subsequent communications with the UE 702, including a Msg2 transmission. Note that the UL spatial filter selected by the UE 702 corresponds to a narrower beam for DL transmission by the NE 704, i.e., there is a corresponding DL spatial filter corresponding to the identified spatial filter.

At step 6 (see signaling 716), the NE 704 transmits the Msg2 using the narrower beam corresponding to the identified spatial filter. In various implementations, the UE 702 and the NE 704 continue to communicate on the narrow beam identified in the beam refinement process, e.g., until the narrow beams become misaligned due to UE mobility or satellite mobility (or both) and handover to a new beam occurs.

In one implementation, the enhanced beam refinement procedure described herein may also be used in the connected mode (e.g., the RRC_CONNECTED state) as the CCS transmission may be needed in the connected mode (e.g., for time and frequency synchronization) and may always be transmitted in the wider beam footprint to meet the DL coverage requirement. Whenever the enhanced beam refinement procedure (i.e., wider-beam-to-narrow-beam technique) using RSs measurements is to be used in the connected mode along with the use in initial access, then following parameters may also be part of RS configuration:
First, the RS configuration may include an enabler indication that indicates whether to carry out measurements on RS for every SSB detection period (e.g., coupled with SSB periodicity) and to perform the UL transmission based on one of the spatial filters from the set of RSs.

Second, the RS configuration may include a time repetition indication, e.g., periodic, aperiodic, or semi-persistent indicating when to use the enhanced beam refinement procedure of detecting wider beam in DL and UL transmission in narrow beam. The network (e.g., NE 704) may set this indication based on type of cells, e.g., earth-moving cells or earth fixed cell, or based on satellite trajectory and altitude.

According to aspects of a second solution, a mapping of synchronization signal and physical broadcast channel (SS/PBCH) blocks with CSI-RS is established. In various implementations, each SSB resource in a set of SSB resources is mapped to a plurality of NZP CSI-RS resources. In one embodiment, each CSI-RS resource in the plurality of NZP CSI-RS resources comprises a single CSI-RS port. In some examples, the plurality of NZP CSI-RS resources corresponds to the narrower beams, whereas the SS/PBCH blocks correspond to the wider beams. Note that each CSI-RS transmission may be associated with a CSI-RS resource identifier or index, used to distinguish between different CSI-RS transmissions.

In one example, a set of candidate SSBs corresponding to N SSB indices, where N≥1, are expected to be received at the UE, wherein each SSB index of the N SSBs indices is exclusively mapped to K NZP CSI-RS resources, wherein K>1. Note that the K NZP CSI-RS resources may share a common higher-layer configuration.

In another example, a set of candidate SSBs corresponding to N SSB indices (where N≥1) are expected to be received at the UE, wherein each SSB index of the N SSBs indices is exclusively mapped to a distinct NZP CSI-RS resource set, i.e., a total of N NZP CSI-RS resource sets exist, and wherein each NZP CSI-RS resource set comprises K NZP CSI-RS resources, wherein K>1.

In one embodiment, the configuration of the K NZP CSI-RS resources within a same NZP CSI-RS resource set may be the same. In another embodiment, the configuration of the N NZP CSI-RS resource sets may be the same.

Regarding the K NZP CSI-RS resources, in certain implementations a first periodicity value associated with the K NZP CSI-RS resources within a same NZP CSI-RS resource set may be equal to a second periodicity value associated with the N SSB indices (corresponding to a set of candidate SSBs). In other words, the periodicity of the K NZP CSI-RS resources may be the same as the SSB periodicity. The periodicity value of the N SSB indices and/or of the K NZP CSI-RS resources may be signaled in SI, such as the MIB, SIB1, SIB2, SIB19, etc.

Similarly, a time offset value associated with the K NZP CSI-RS resources within a same NZP CSI-RS resource set may be equal to an offset value that the UE computes with respect to a reception time of the set of candidate SSBs (i.e., the N SSB indices). Note that the network (i.e., base station) may configure the UE with offset values indicating time occasions in which CSI-RS is transmitted, where the UE calculates the specific offset value for a particular NZP CSI-RS resource. The time offset value of the N SSB indices and/or of the K NZP CSI-RS resources may be signaled in SI, such as the MIB, SIB1, SIB2, SIB19, etc.

In some implementations, the UE is expected to receive a configuration of the NZP CSI-RS resource sets or a configuration of the NZP CSI-RS resources, or both, over an SIB message. In some examples, the SIB message is associated with NTN communication, e.g., SIB19.

In certain implementations, a configuration corresponding to an NZP CSI-RS resource set does not comprise any optional parameters in a set of parameters of an RRC message carrying information of characteristics of the NZP CSI-RS resource sets. Note that the CSI-RS configuration is a dedicated configuration which may include a very large set of parameters. However, the procedure to select and indicate a narrow beam for dedicated signaling, as described herein, does not require such a large configuration. Rather, a configuration comparable to SSB configuration parameters may be sufficient for this procedure. Accordingly, the base station may broadcast a reduced size CSI-RS configuration for beam management, wherein the optional parameters (i.e., the CSI-RS parameters not required for beam management) are omitted. Beneficially, broadcasting the reduced size configuration during initial access reduces power usage and improves network efficiency. Additionally, the base station may later transmit the fill CSI-RS configuration to the UE when in connected mode.

In another embodiment, a configuration corresponding to an NZP CSI-RS resource may not comprise a power control offset corresponding to a DM-RS, a PDSCH transmission, or a power control offset value with respect to a reference synchronization signal. The power control offset is value configured by the network in CSI-RS configuration to describe the CSI-RS power offset with respect to other signals such as PDSCH; however, there is no power offset value associated with SSB. Accordingly, for the CSI-RS for beam management, the CSI-RS configuration for the proposed method would not need a power offset value, similar to SSB. In such implementations, a periodicity-and-offset value (i.e., time offset indicating value time occasions in which CSI-RS is transmitted) is not reported.

In some implementations, a group of NZP CSI-RS resources mapped to a same SS/PBCH block transmission are expected to be mutually QCL'ed with respect to QCL-TypeA. For example, an NZP CSI-RS resource in the group of NZP CSI-RS resources that is mapped to a particular SS/PBCH block transmission may be expected to be QCL'ed with that particular SS/PBCH block with respect to QCL-TypeA properties (i.e., the Doppler shift, the Doppler spread, the average delay, and the delay spread). However, the NZP CSI-RS resource is not expected to be QCL'ed with the particular SS/PBCH block transmission with respect to QCL-TypeD (i.e., spatial Rx parameter(s)).

According to aspects of a third solution, the UE receives a mapping configuration of the reference symbols (or resource set) with wider beams carrying CCS (e.g., SSBs) to perform measurements on the RSs associated with the detected wider beams (e.g., SSB) and to distinguish which spatial filter is to be used by the UE in UL transmission and for subsequent DL transmission by the base station, whereas the configuration is part of SI broadcast message for idle/inactive state or connected state UEs.

In some implementations, the parameters of the mapping configuration may include a set of reference symbols (e.g., a CSI resource set) for each wider beam carrying CCS (e.g., SSB). In some implementations, the parameters of the mapping configuration may include a mapping relationship of the RSs (or resource set) of the SSB with time and frequency resources assigned for preamble transmission.

In certain implementations, a trivial mapping of the RSs with an SSB index is used. In some examples, the m^{th} wide beam (e.g., SSB index m) is associated with an RS set (e.g., CSI-RS) comprised of RS indices from (m−1)×(K+1) to m×K. When this type of mapping is used, one or more of the following implementations may be realized:

In one implementation, the UE may be explicitly configured with a single parameter K indicating number of RSs (e.g., CSI-RS resources) associated with an SSB. This would imply that the same number of RSs are associated with all of the SSBs.

In one implementation, when the number of reference symbols associated with an SSB are not same for each of the SSBs, then a separate parameter indicating the number of reference symbols for each of the SSB is included in the configuration.

In one implementation, when the number of RSs is equally divided for each of the SSB, then the UE might not receive a parameter (or an indication thereof) for the association of RSs with an SSB. In such a situation, the UE may interpret the lack of such a parameter as an implicit indication to the UE that the number of reference symbols associated with all of the SSBs are the same. Therefore, the UE would divide the number of configured resource signals with the number of SSBs and calculate the number of RSs for each of the SSBs.

In one implementation, the UE may also be explicitly configured with a parameter m indicating the number of configured wide beams (e.g., SSBs).

In other implementations, the number of RSs associated with an SSB may be pre-defined and/or fixed for different frequency spectrum.

In some implementations, an association of resource sets (i.e., comprising of number of RSs) with the wider beam indices (e.g., SSB indices) is used to define the mapping relation, e.g., L resource sets (e.g., comprising of CSI-RS resources) are configured with M wide beams (e.g., SSB beams) where L=M. In such implementations, resources of the l^{th} resource set are mapped to the m^{th} wide beam. When this type of mapping is used, one or more of the following implementations may be realized:

In one implementation, a one-to-one mapping relationship is realized that implicitly indicates that each resource set index corresponds to an SSB index in the descending order, e.g., RS part of resource set ID #1 is to be used for SSB index #1, RS part of resource set ID #2 is to be used for SSB index #2, and so on.

In one implementation, a one-to-one mapping relationship is realized, where a defined pattern is used in the configuration to indicate which resource set ID corresponds to which SSB index. For example, a resource set ID mapping may be configured as {2,1,4,3} thereby indicating that resource set ID #2 would correspond to SSB index #1, resource set ID #1 would correspond to SSB index #2, resource set ID #4 would correspond to SSB index #3, and resource set ID #3 would correspond to SSB index #4.

In one example, the PRACH configuration includes the mapping information of RSs (or resource set) corresponding to the SSB indices along with time and frequency resources where these resources may correspond to one RACH occasion, or multiple RACH occasions, of an SSB index.

In one example, the reference symbols (or a resource set) corresponding to each SSB may be defined in a SIB message, e.g., SIB19 dedicated for NTN UEs, thus this may implicitly indicate to the UE that it needs to perform measurements on the set of RSs of the SSB without any need of additional indication.

According to aspects of a fourth solution, the network (e.g., base station) assigns a reporting mechanism for the UE to report which spatial filter is used for UL transmission while performing initial access procedure (i.e., for PRACH transmission) or during connected state. In various implementations, this reporting mechanism may be based on a set of defined rules.

In one embodiment, the RS configuration includes an indication of the assigned reporting mechanism. In another embodiment, the RS configuration lacks the indication of the assigned reporting mechanism. As described herein, the spatial filter corresponds to at least one of the RSs from the set of RSs associated with at least one of the wider beams.

In one implementation, the reporting of the spatial filter, that is selected based on one of the RSs from the set of RSs, is based on mapping relation of RS to the frequency and time resources assigned for RACH occasions of an SSB.

In one example, a one-to-one mapping of RSs with RACH occasions of an SSB is defined e.g., each RACH occasion of the detected SSB would be implicitly used for one of the RSs. The mapping of RSs to the RACH occasions may be defined in ascending or descending order. For instance, if a UE is configured with 4 RSs for each of the SSB, then in this case, one SSB would be associated with at least 4 RACH occasions. In one embodiment, the base station may indicate the mapping of 4 RS to each SSB using the parameter ssb-perRACH-OccasionAndCB-PreamblesPerSSB set to the value ‘¼’.

In certain implementations, the UE may use the first RACH occasion for transmission of the UL signal (e.g., RACH preamble) if the first RSs from the set of configured RSs is selected, the second RACH occasion if the second RSs is selected, and so on. In such implementations, the base station may monitor these RACH occasions with different spatial filters that are based on one-to-one mapping of RSs with RACH occasions of an SSB.

In one implementation, a mapping relation of RSs to the time and frequency resources is also configured, thus defining which RACH occasion corresponds to which RS.

In one implementation, the mapping relation of RSs to the SSB is based on preamble distribution, where a set of preambles may be defined (or configured) for each of the RSs within a wider beam footprint. For example, the total number of preambles may be divided into sets corresponding to the number of RSs of an SSB, and UE would transmit on the assigned RACH occasion with one of the preambles from the corresponding set. In such implementations, the base station (e.g., gNB) may detect the selected RS for UL transmission based on the transmitted preambles.

In one example, the mapping of preamble to RSs is based on ascending order where the first preamble set would correspond to first RS, second set to the second RS, and so on. Alternatively, the base station may also define, e.g., in the configuration, information about the mapping relation of the preambles with the RSs.

In some implementations, the UE may be located at a boundary between two narrow beams within the wider beam, therefore the two RSs (i.e., corresponding to the two narrow beams) may result in similar measurements. In such implementations, the UE may indicate two RSs to the base station, e.g., by transmitting preamble on multiple RACH occasions corresponding to the RSs.

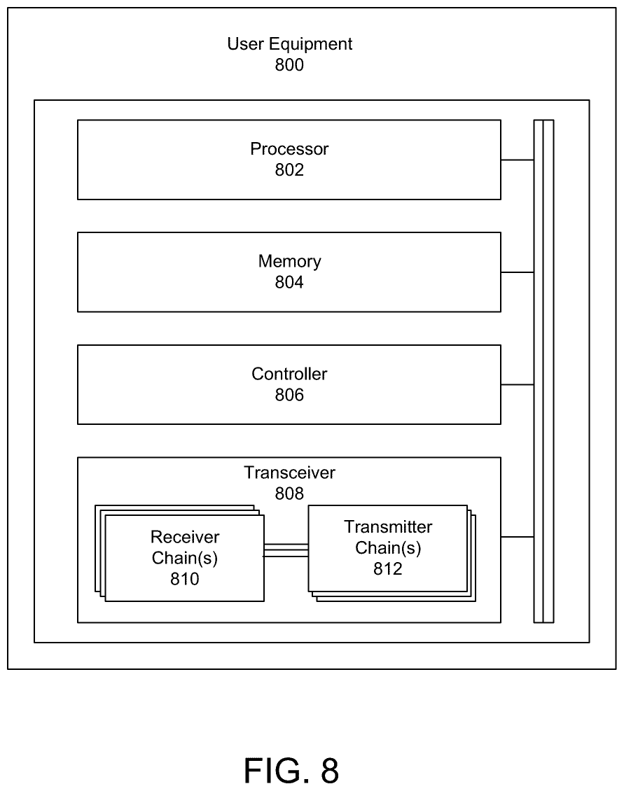

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a central processing unit (CPU), an ASIC, a field programmable gate array (FPGA), or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions that, when executed by the processor 802, cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform various functions (e.g., operations, signaling) described herein (e.g., executing, by the processor 802, instructions stored in the memory 804). In some implementations, the processor 802 may include multiple processors and the memory 804 may include multiple memories. One or more of the multiple processors may be coupled with one or more of the multiple memories, which may be individually or collectively, configured to perform various functions (e.g., operations, signaling) of the UE described herein.

The processor 802 coupled with the memory 804 may be configured to, capable of, or operable to cause the UE 800 to receive information that indicates a first set of beams mapping to a second set of beams including at least one group of beams. Each beam in the first set of beams may be mapped to the at least one group of beams of the second set of beams. The processor 802 coupled with the memory 804 may be configured to, capable of, or operable to cause the UE 800 to select a beam of the first set of beams. Additionally, the processor 802 coupled with the memory 804 may be configured to, capable of, or operable to cause the UE 800 to perform a set of one or more measurements on at least one beam of the at least one group of beams of the second set of beams, where the at least one beam corresponds to the selected beam of the first set of beams. The processor 802 coupled with the memory 804 may be configured to, capable of, or operable to cause the UE 800 to perform wireless communication based at least in part on the performed set of one or more measurements.

In some implementations, each beam of the first set of beams is associated with a SSB resource. In some implementations, each beam of the second set of beams is associated with a NZP CSI-RS resource.

In some implementations, the first set of beams includes a plurality of beams encompassing the at least one group of beams of the second set of beams. In some implementations, a number (e.g., quantity) of beams in the first set of beams is equal to a number (e.g., quantity) of groups of beams in the second set of beams.

In some implementations, the information indicates a first number (e.g., first quantity) of beams associated with the first set of beams, a second number (e.g., second quantity) of beams associated with the second set of beams, or a size (e.g., count) of the at least one group of beams of the second set of beams.

In some implementations, the information comprises a SIB. In some implementations, information includes a mapping of a SSB index to a NZP CSI-RS resource set comprising a plurality of NZP CSI-RS resources. In some implementations, the plurality of NZP CSI-RS resources mapped to an SSB are mutually QCL'ed with respect to at least a Doppler shift, a Doppler spread, an average delay, or a delay spread. In some implementations, a respective NZP CSI-RS resource mapped to an SSB is QCL'ed with respect to at least a Doppler shift, a Doppler spread, an average delay, or a delay spread.

In some implementations, the information further indicates a first periodicity value associated with SSB transmission on the first set of beams, and a second periodicity value applicable for each resource of the plurality of NZP CSI-RS resources. In some implementations, each NZP CSI-RS resource within the NZP CSI-RS resource set is associated with a same periodicity value. In some implementations, the information further indicates an offset value applicable for each resource of the plurality of NZP CSI-RS resources based on a reception time of a set of SSB transmissions. In some implementations, each NZP CSI-RS resource of the NZP CSI-RS resource set is associated with a same offset value.

In some implementations, the information further indicates the at least one beam of the at least one group of beams of the second set of beams to perform the set of one or more measurements.

In some implementations, the processor 802 coupled with the memory 804 may be configured to, capable of, or operable to cause the UE 800 to transmit a CSI report during a RACH occasion associated with the selected beam. In some implementations, the CSI report comprises an indication of a spatial filter corresponding to at least one reference signal from a set of reference signals associated with a beam from the first set of beams.

In some implementations, the processor 802 coupled with the memory 804 may be configured to, capable of, or operable to cause the UE 800 to determine a set of RACH resources corresponding to the second set of beams, and transmit a RACH signal (e.g., perform a RACH transmission) using a RACH resource corresponding to a selected beam of the second set of beams.

The controller 806 may manage input and output signals for the UE 800. The controller 806 may also manage peripherals not integrated into the UE 800. In some implementations, the controller 806 may utilize an operating system (OS) such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for /coding/ processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

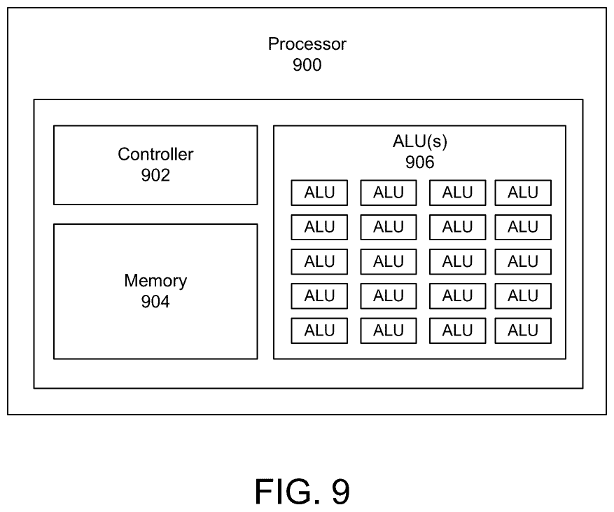

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1, or L2, or L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

In some implementations, the processor 900 may support various functions (e.g., operations, signaling) of a UE, in accordance with examples as disclosed herein. For example, the controller 902 coupled with the memory 904 may be configured to, capable of, or operable to cause the processor 900 to receive information that indicates a first set of beams mapping to a second set of beams comprising at least one group of beams, each beam in the first set of beams is mapped to the at least one group of beams of the second set of beams; select a beam of the first set of beams; perform a set of one or more measurements on at least one beam of the at least one group of beams of the second set of beams, where the at least one beam corresponds to the selected beam of the first set of beams; and perform wireless communication based at least in part on the performed set of one or more measurements. Additionally, the controller 902 coupled with the memory 904 may be configured to, capable of, or operable to cause the processor 900 to perform one or more functions (e.g., operations, signaling) of the UE as described herein.

Additionally, or alternatively, in some other implementations, the processor 900 may support various functions (e.g., operations, signaling) of a NE (e.g., base station), in accordance with examples as disclosed herein. For example, the controller 902 coupled with the memory 904 may be configured to, capable of, or operable to cause the processor 900 to transmit information that indicates a first set of beams mapping to a second set of beams comprising at least one group of beams, wherein each beam in the first set of beams is mapped to the at least one group of beams of the second set of beams and perform wireless communication based at least in part on the transmitted information. Additionally, the controller 902 coupled with the memory 904 may be configured to, capable of, or operable to cause the processor 900 to perform one or more functions (e.g., operations, signaling) of the NE as described herein.

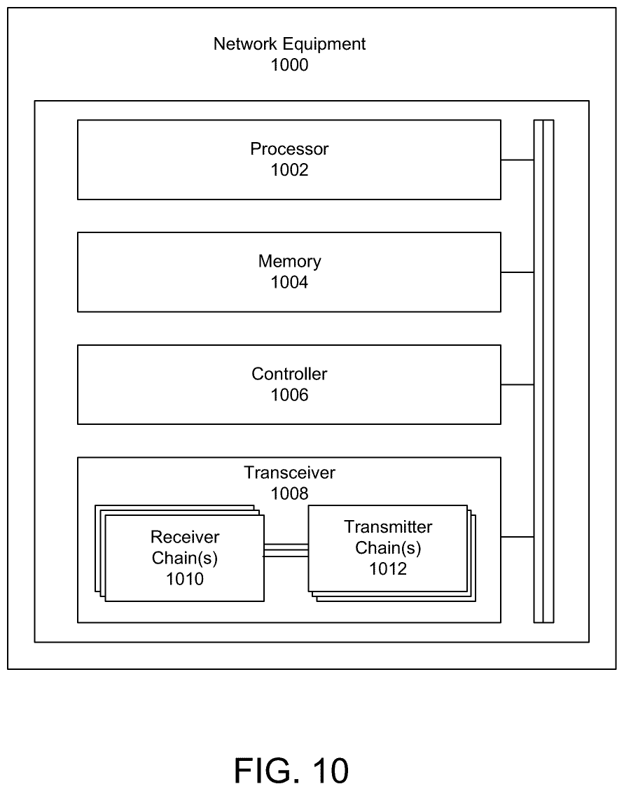

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform various functions (e.g., operations, signaling) described herein (e.g., executing, by the processor 1002, instructions stored in the memory 1004). In some implementations, the processor 1002 may include multiple processors and the memory 1004 may include multiple memories. One or more of the multiple processors may be coupled with one or more of the multiple memories, which may be individually or collectively, configured to perform various functions (e.g., operations, signaling) of the NE 1000 as described herein.

The processor 1002 coupled with the memory 1004 may be configured to, capable of, or operable to cause the NE 1000 to transmit information that indicates a first set of beams mapping to a second set of beams comprising at least one group of beams, wherein each beam in the first set of beams is mapped to the at least one group of beams of the second set of beams; and perform wireless communication based at least in part on the transmitted information.

The processor 1002 coupled with the memory 1004 may be configured to, capable of, or operable to cause the NE 1000 to receive, from a UE, a RACH signal (e.g., a RACH transmission) on a RACH resource; and determine a spatial filter for the UE based on the information and a set of RACH resources corresponding to the second set of beams.

In some implementations, each beam of the first set of beams is associated with a SSB resource (e.g., for SSB transmission). In some implementations, each beam of the second set of beams is associated with a NZP CSI-RS resource (e.g., for CSI-RS transmission).

In some implementations, the first set of beams comprises a plurality of beams encompassing the at least one group of beams of the second set of beams. In some implementations, a number (e.g., quantity) of beams in the first set of beams is equal to a number (e.g., quantity) of groups of beams in the second set of beams.

In some implementations, the information indicates a first number (e.g., quantity) of beams associated with the first set of beams (e.g., SSB beams), a second number (e.g., quantity) of beams associated with the second set of beams (e.g., CSI-RS), or a size (e.g., count, footprint) of the at least one group of beams of the second set of beams.

The processor 1002 coupled with the memory 1004 may be configured to, capable of, or operable to cause the NE 1000 to receive a CSI report during a RACH occasion associated with a beam corresponding to the spatial filter. In some implementations, the CSI report comprises an indication of a selected spatial filter corresponding to at least one reference signal from a set of reference signals associated with a beam from the first set of beams.

In some implementations, the information comprises a SIB. In some implementations the SIB includes a mapping of an SSB index to a NZP CSI-RS resource set including a plurality of NZP CSI-RS resources. In some implementations, the plurality of NZP CSI-RS resources mapped to an SSB are mutually QCL'ed with QCL-TypeA properties. In other words, the NZP CSI-RS resources are mutually QCL'ed with respect to at least a Doppler shift, a Doppler spread, an average delay, or a delay spread.

In some implementations, a respective NZP CSI-RS resource mapped to an SSB is QCL'ed with QCL-TypeA properties. In other words, the NZP CSI-RS resource may be QCL'ed with the SSB with respect to at least a Doppler shift, a Doppler spread, an average delay, or a delay spread.

In some implementations, the information further indicates a first periodicity value associated with SSB transmission on the first set of beams, and a second periodicity value applicable for each resource of the plurality of NZP CSI-RS resources. In some implementations, each NZP CSI-RS resource of the NZP CSI-RS resource set is associated with a same periodicity value.

In some implementations, the information further indicates an offset value applicable for each resource of the plurality of NZP CSI-RS resources based on a reception time of a set of SSB transmissions. In some implementations, each NZP CSI-RS resource of the NZP CSI-RS resource set is associated with a same offset value.

In some implementations, the information further indicates the at least one beam of the at least one group of beams of the second set of beams to perform the set of one or more measurements.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for /coding/ processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

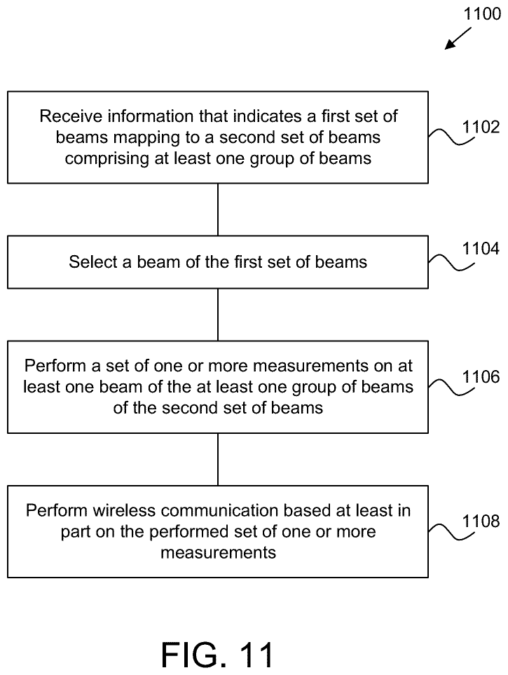

FIG. 11 depicts one embodiment of a method 1100 in accordance with aspects of the present disclosure. The operations of the method 1100 may be implemented by a UE as described herein. In some implementations, the UE may execute a set of instructions to control the function elements of the UE to perform the described functions.

At step 1102, the method 1100 may include receiving information that indicates a first set of beams mapping to a second set of beams comprising at least one group of beams. Each beam in the first set of beams may be mapped to the at least one group of beams of the second set of beams. The operations of step 1102 may be performed in accordance with examples as described herein. In some implementations, aspects of the operations of step 1102 may be performed by a UE 800 as described with reference to FIG. 8.

At step 1104, the method 1100 may include selecting a beam from the first set of beams. The operations of step 1104 may be performed in accordance with examples as described herein. In some implementations, aspects of the operations of step 1104 may be performed by a UE 800 as described with reference to FIG. 8.

At step 1106, the method 1100 may include performing a set of one or more measurements on at least one beam of the at least one group of beams of the second set of beams. The at least one beam corresponds to the selected beam of the first set of beams. The operations of step 1106 may be performed in accordance with examples as described herein. In some implementations, aspects of the operations of step 1106 may be performed by a UE 800 as described with reference to FIG. 8.

At step 1108, the method 1100 may include performing wireless communication based at least in part on the performed set of one or more measurements. The operations of step 1108 may be performed in accordance with examples as described herein. In some implementations, aspects of the operations of step 1108 may be performed by a UE 800 as described with reference to FIG. 8.

It should be noted that the method 1100 described herein describes one possible implementation, and that the operations and the steps may be rearranged or otherwise modified and that other implementations are possible.

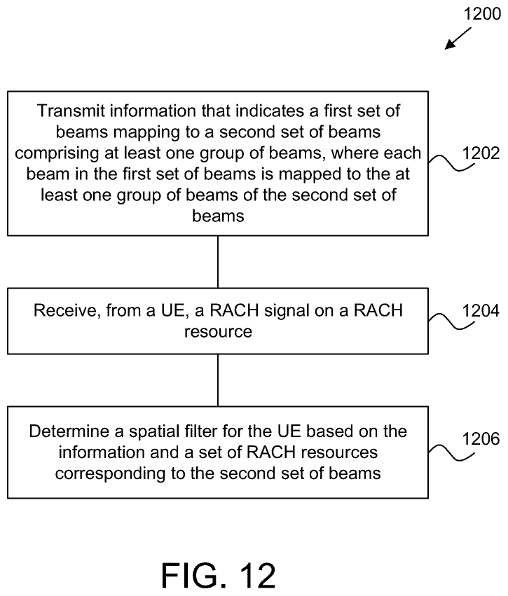

FIG. 12 depicts one embodiment of a method 1200 in accordance with aspects of the present disclosure. The operations of the method 1200 may be implemented by a NE (e.g., base station) as described herein. In some implementations, the NE may execute a set of instructions to control the function elements of the NE to perform the described functions.

At step 1202, the method 1200 may include transmitting information that indicates a first set of beams mapping to a second set of beams comprising at least one group of beams, where each beam in the first set of beams is mapped to the at least one group of beams of the second set of beams. The operations of step 1202 may be performed in accordance with examples as described herein. In some implementations, aspects of the operations of step 1202 may be performed by a NE, as described with reference to FIG. 10.

At step 1204, the method 1200 may include, optionally, receiving, from a UE, a RACH signal on a RACH resource. The operations of step 1204 may be performed in accordance with examples as described herein. In some implementations, aspects of the operations of step 1204 may be performed by a NE, as described with reference to FIG. 10.

At step 1206, the method 1200 may include, optionally, determining a spatial filter for the UE based on the information and a set of RACH resources corresponding to the second set of beams. The operations of step 1206 may be performed in accordance with examples as described herein. In some implementations, aspects of the operations of step 1206 may be performed by a NE, as described with reference to FIG. 10.

It should be noted that the method 1200 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive information that indicates a first set of beams mapping to a second set of beams comprising at least one group of beams, wherein each beam in the first set of beams is mapped to the at least one group of beams of the second set of beams;
select a beam of the first set of beams;
perform a set of one or more measurements on at least one beam of the at least one group of beams of the second set of beams, wherein the at least one beam corresponds to the selected beam of the first set of beams; and
perform wireless communication based at least in part on the performed set of one or more measurements.

2. The UE of claim 1, wherein each beam of the first set of beams is associated with a synchronization signal block (SSB) resource, and wherein each beam of the second set of beams is associated with a non-zero power (NZP) channel state information (CSI) reference signal (CSI-RS) resource.

3. The UE of claim 1, wherein the first set of beams comprises a plurality of beams encompassing the at least one group of beams of the second set of beams, and wherein a number of beams in the first set of beams is equal to a number of groups of beams in the second set of beams.

4. The UE of claim 1, wherein the information indicates a first number of beams associated with the first set of beams, a second number of beams associated with the second set of beams, or a size of the at least one group of beams of the second set of beams.

5. The UE of claim 1, wherein the information comprises a system information block (SIB), and wherein the SIB includes a mapping of a synchronization signal block (SSB) index to a non-zero power (NZP) channel state information (CSI) reference signal (CSI-RS) resource set comprising a plurality of NZP CSI-RS resources.

6. The UE of claim 5, wherein the plurality of NZP CSI-RS resources mapped to an SSB are mutually quasi-co-located (QCL'ed) with respect to at least a Doppler shift, a Doppler spread, an average delay, or a delay spread.

7. The UE of claim 5, wherein a respective NZP CSI-RS resource mapped to an SSB is quasi-co-located (QCL'ed) with respect to at least a Doppler shift, a Doppler spread, an average delay, or a delay spread.

8. The UE of claim 5, wherein the information further indicates a first periodicity value associated with SSB transmission on the first set of beams, and a second periodicity value applicable for each resource of the plurality of NZP CSI-RS resources, and wherein each NZP CSI-RS resource within the NZP CSI-RS resource set is associated with a same periodicity value.

9. The UE of claim 5, wherein the information further indicates an offset value applicable for each resource of the plurality of NZP CSI-RS resources based on a reception time of a set of SSB transmissions, and wherein each NZP CSI-RS resource of the NZP CSI-RS resource set is associated with a same offset value.

10. The UE of claim 1, wherein the information further indicates the at least one beam of the at least one group of beams of the second set of beams to perform the set of one or more measurements.

11. The UE of claim 1, wherein the at least one processor is configured to cause the UE to:
transmit a channel state information (CSI) report during a random access channel (RACH) occasion associated with the selected beam,
wherein the CSI report comprises an indication of a spatial filter corresponding to at least one reference signal from a set of reference signals associated with a beam from the first set of beams.

12. The UE of claim 1, wherein the at least one processor is configured to cause the UE to:
determine a set of random access channel (RACH) resources corresponding to the second set of beams; and
transmit a RACH signal using a RACH resource corresponding to a selected beam of the second set of beams.

13. A processor for wireless communication, comprising:
at least one controller coupled with at least one memory and configured to cause the processor to:
receive information that indicates a first set of beams mapping to a second set of beams comprising at least one group of beams, wherein each beam in the first set of beams is mapped to the at least one group of beams of the second set of beams;
select a beam of the first set of beams;
perform a set of one or more measurements on at least one beam of the at least one group of beams of the second set of beams, wherein the at least one beam corresponds to the selected beam of the first set of beams; and
perform wireless communication based at least in part on the performed set of one or more measurements.

14. A base station for wireless communication, comprising:
at least one memory; and
at least one processor coupled with the at least one memory and configured to cause the base station to:
transmit information that indicates a first set of beams mapping to a second set of beams comprising at least one group of beams, wherein each beam in the first set of beams is mapped to the at least one group of beams of the second set of beams; and
perform wireless communication based at least in part on the transmitted information.

15. The base station of claim 14, wherein the at least one processor is further configured to cause the base station to:
receive, from a user equipment (UE), a random access channel (RACH) signal on a RACH resource; and
determine a spatial filter for the UE based on the information and a set of RACH resources corresponding to the second set of beams.

16. The base station of claim 14, wherein each beam of the first set of beams is associated with a synchronization signal block (SSB) resource, and wherein each beam of the second set of beams is associated with a non-zero power (NZP) channel state information (CSI) reference signal (CSI-RS) resource.

17. The base station of claim 14, wherein the first set of beams comprises a plurality of beams encompassing the at least one group of beams of the second set of beams, and wherein a number of beams in the first set of beams is equal to a number of groups of beams in the second set of beams.

18. The base station of claim 14, wherein the information indicates a first number of beams associated with the first set of beams, a second number of beams associated with the second set of beams, or a size of the at least one group of beams of the second set of beams.

19. The base station of claim 14, wherein the at least one processor is configured to cause the base station to:
receive a channel state information (CSI) report during a random access channel (RACH) occasion associated with a beam corresponding to the spatial filter,
wherein the CSI report comprises an indication of a selected spatial filter
corresponding to at least one reference signal from a set of reference signals associated with a beam from the first set of beams.

20. A method performed by a user equipment (UE) for wireless communication, the method comprising:
receiving information that indicates a first set of beams mapping to a second set of beams comprising at least one group of beams, wherein each beam in the first set of beams is mapped to the at least one group of beams of the second set of beams;
selecting a beam of the first set of beams;
performing a set of one or more measurements on at least one beam of the at least one group of beams of the second set of beams, wherein the at least one beam corresponds to the selected beam of the first set of beams; and
performing wireless communication based at least in part on the performed set of one or more measurements.
